(19) United States
(12) Patent Application Publication
(10) Pub. No.: US 2007/0258595 A1
(43) Pub. Date: Nov. 8, 2007

(54) Syncronizing Device-Specific Encrypted Data to and from Mobile Devices Using Detachable Storage Media

(75) Inventor: Hanford Chan Choy, Los Altos, CA (US)

Correspondence Address: GREENBERG TRAURIG, LLP, 77 WEST WACKER DRIVE, SUITE 2500, CHICAGO, IL, 60601-1732, US

(73) Assignee: Universal Electronics Inc., Cypress, CA (US)

(21) Appl. No.: 10/592,156

(22) PCT Filed: Mar. 10, 2005
(86) PCT No.: PCT/US05/08215

§ 371 Date: Jun. 8, 2007

Related U.S. Application Data
(60) Provisional application No. 60/552,346, filed on Mar. 11, 2004.

(51) Int. Cl. H04L 9/30

(52) U.S. Cl. 380/278

(57) ABSTRACT

A system and method for transferring encrypted data between a data source device and a data target device is en-closed. A system is also disclosed for using a detachable media to enable software applications on each device (target and source) to select an appropriate public key for specific data types to accomplish synchronization of encrypted file between a first electronic device and a second mobile or portable device.

### RELATED APPLICATION DATA

This application claims the benefit of U.S. Provisional Application Ser. No. 60/552,346, filed Mar. 11, 2004, which application is hereby incorporated by reference in its entirety.

### BACKGROUND

The following relates generally to a system and method for synchronizing encrypted data between multiple devices, for example a content acquisition device and a mobile or portable device such as an automotive or hand-held device. Specifically, the invention discloses a system that uses detachable storage media as an exchange medium to synchronize device specific encrypted data.

### SUMMARY OF THE INVENTION

In accordance with this and other needs, the following generally discloses a system and method for synchronizing encrypted data between one device and a mobile or portable device, such as an automotive or hand-held device using detachable storage media such as compact flash cards, USB flash drives, USB hard disk drives, R/W CD-ROMs, R/W DVD discs, Microdrives, etc. A method of transferring encryption information is described wherein various synchronization tasks able to be performed by a mobile or portable device are available for encrypted files which would not normally be able to synchronize with the mobile or portable device. A system is also disclosed for using a detachable storage media and an associated key management system that resides on detachable storage media to enable software applications on each device to select an appropriate public key for specific data types to accomplish synchronization of encrypted filed between a first electronic device and a second mobile or portable device.

A better appreciation of the objects, advantages, features, properties, and relationships of the disclosed encryption synchronization method and system will be obtained from the following detailed description and accompanying drawings which set forth illustrative embodiments which are indicative of the various ways in which the principles described hereinafter may be employed.

### BRIEF DESCRIPTION OF THE DRAWINGS

For use in better understanding the exemplary synchronization system described hereinafter reference may be had to the following drawings in which:

FIG. 1 illustrates an exemplary mobile device;

FIG. 2 illustrates an exemplary block diagram of components in a mobile device;

FIG. 3 illustrates an exemplary block diagram of a typical use case in which encrypted data is retrieved from the Internet, as well as generated on a PC, then synchronized to a mobile device using a detachable storage media;

FIG. 4 illustrates an exemplary block diagram of components used to synchronize encrypted data to mobile devices using a public key stored on a detachable storage media;

FIG. 5 illustrates an exemplary flowchart describing the process to initialize the public key store on a detachable storage media;

FIG. 6 illustrates a flowchart describing an exemplary process to synchronize encrypted Internet data to a mobile device using a detachable storage media;

FIG. 7 illustrates a flowchart describing an exemplary process to synchronize encrypted ripped data to a mobile device using a detachable storage media;

FIG. 8 illustrates a flowchart describing an exemplary process to synchronize encrypted data generated at a mobile device to a target device using a detachable storage media;

FIG. 9 illustrates a flowchart describing an exemplary process to encrypt two types of automotive information destined for two Internet service providers; and

FIG. 10 illustrates a flowchart describing an exemplary process to browse a detachable storage media, then render the encrypted data that is selected by a user.

### DETAILED DESCRIPTION

The present invention can find utility in a variety of implementations without departing from the scope and spirit of the invention, as will be apparent from an understanding of the principles that underlie the invention. Reference is made throughout this description of the invention to a mobile device such as may be found, for example, installed in an automobile. However, it is to be understood that the particular synchronization and content acquisition system and method described herein may be generally applied for portable, fixed, and mobile devices of any kind, including but not limited to laptop computers, audio players, video players, set top boxes (STBs), remote controls, automobile radio, computing or telematics systems, portable phones, watches, webpads, and the like. It will be further understood that while the present invention is primarily described in relation to battery powered mobile and portable devices, the inventive concepts may be applied to electronic devices requiring synchronization and content acquisition functions generally, including line powered device which require no batteries. Accordingly, for ease of description all such devices to which encrypted content is to be transferred whether portable, fixed, mobile, and battery or line powered are collectively referred to herein as mobile or target devices.

A significant hurdle with synchronizing encrypted content using public key infrastructure (PKI) and detachable storage media, such as compact flash cards, USB flash drives, and USB hard disk drives, is the exchange of public keys. When two devices are networked via Ethernet or other similar network, exchange of public keys can occur between the two computer systems via the network, prior to or in conjunction with the network transfer of the content itself. However, when no suitable network infrastructure is available for communication or data transfer, in accordance with the principles of this invention the exchange of data between the two computer systems may be accomplished using detachable storage media that does not contain a processor, where the detachable storage media itself must act as the medium to exchange public keys.

In an exemplary embodiment, before data can be encrypted and given to a mobile device, a public key associated with the mobile device is copied to the detachable storage media. A user then disconnects the detachable storage media from the mobile device, and connects the detachable storage media to the source device. The source device uses the public key stored on the detachable storage media to encrypt data for the mobile device, then copies the encrypted data to the detachable storage media. When a user subsequently inserts the detachable storage media containing encrypted data into the target mobile device, the mobile device uses its private key to decrypt the data and render the data. For example, if the encrypted data is a Windows Media Audio (WMA) audio track, the mobile device uses its private key to decrypt the audio and render the audio with a WMA decoder rendering engine; if the synchronized data is an oil change reminder, the mobile device decrypts the reminder and renders the oil change reminder on a text or GUI display in the automobile.

In an exemplary embodiment, a user may purchase encrypted data from an Internet content provider. The encrypted data may be cached or stored on a PC, Server, or other similar electronic device (Source Device) in a user's home. As initially purchased, this data may be normally renderable only on the source device or other device on which it is stored. To synchronize this encrypted data to a mobile device using detachable storage media, the user may first insert the detachable storage media in the mobile device, whereupon the mobile device copies the public key associated with the mobile device onto the detachable storage media (in one embodiment, this step only needs to be performed once for each detachable storage media). The user may then remove the detachable storage media from the mobile device and insert the detachable storage media into the source device. The source device may then, automatically or under user command, transcrypt the cached or stored encrypted data using (a) the private key of the encrypted data and (b) the public key of the mobile device and may copy this newly re-encrypted data onto the detachable storage media. The encrypted data now stored on the detachable storage media may then be decrypted and accessed by the mobile device using the mobile device's private key.

Since the computations involved in such asymmetrical public/private key encryption algorithms may be intensive, it will be appreciated by those of skill in the art that this technique may alternatively be used to effect the one-time transfer of a secret, fixed, symmetrical key value (which may be a key originally supplied in conjunction with the purchase of the content, may be a newly randomly generated key, etc., as appropriate) which may then be used to decrypt the balance of the content data in a less computationally intensive manner. Such an approach may be applied on a per-item basis, a per-album basis, a per-session basis, as appropriate. It should thus be understood that the terms encrypt/encryption and decrypt/decryption, when used herein in the context of data transfer between a mobile device and a source device, are intended to encompass all methods and techniques characterized by an initial transfer of a key value from a mobile device to a source device.

Likewise, in one particular embodiment a mobile automotive device may use the same or similar mechanism to transfer encrypted data, such as engine diagnostics, tire wear, etc. to a source device or other storage or gateway device, which may then either render the data, send the data to another node in a home network, or relay the data in original or re-encrypted form to an Internet service provider, for example, to be examined by a provider of vehicle repair/maintenance services.

Description of Mobile Device Hardware

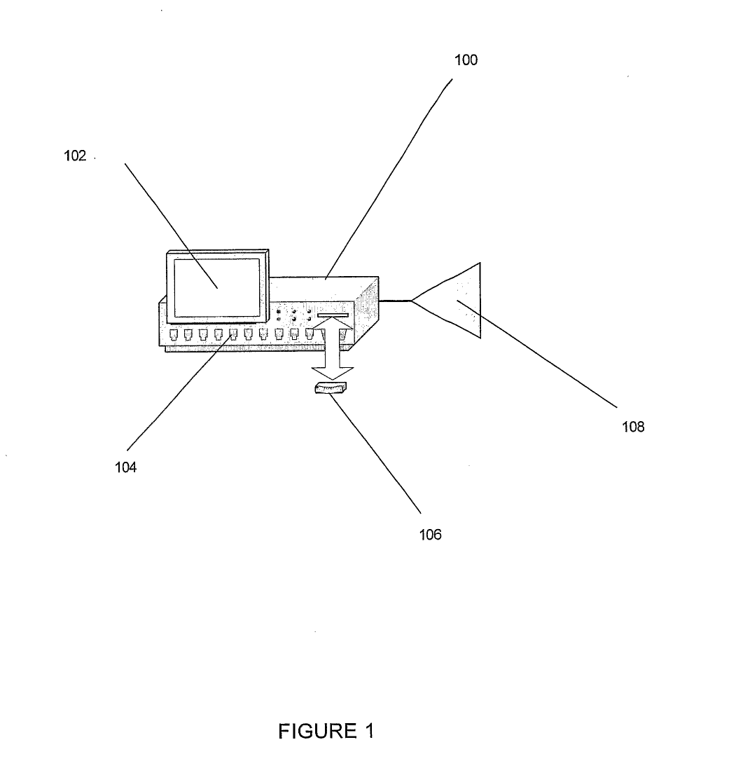

FIG. 1 shows an exemplary mobile device 100 that includes a display 102, function buttons 104 for interfacing with a user interface that controls an operating system and software applications, and speakers 108, together with detachable storage media 106 that can be plugged into the mobile device 100. The display 102 may be a text-only display or a multimedia display that renders text and graphics.

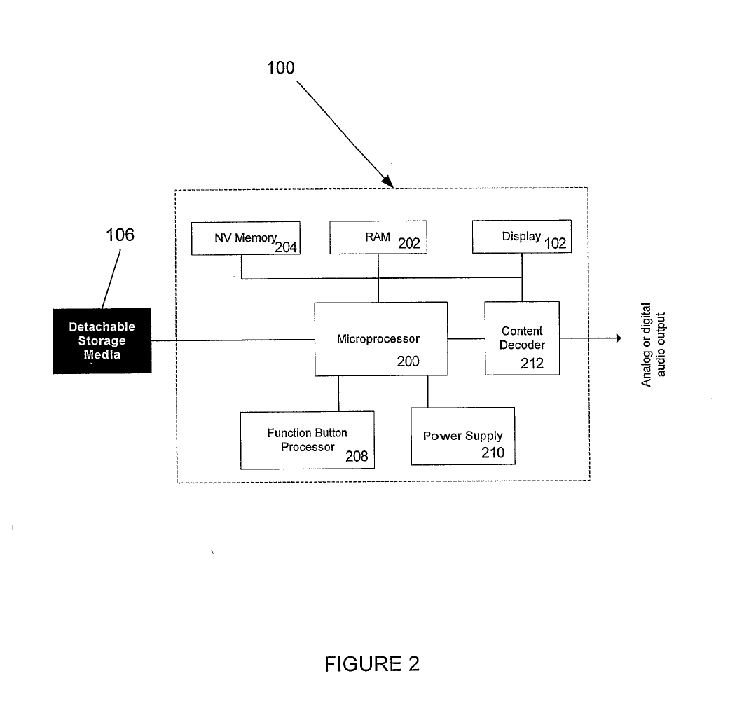

FIG. 2 shows an exemplary hardware block diagram of mobile device 100 that includes a microprocessor 200, RAM system memory 202, non-volatile memory 204 such as flash, EEPROM, etc., power supply 210, function button processor 208, display 102, all as are well understood in the art, together with detachable storage media 106. In one embodiment microprocessor 200 may be an automotive grade platform, such as the TI OMAP5905 OSK platform, or the Renesas and Freescale telematics platforms.

Description of Detachable Storage Media Usage Scenario

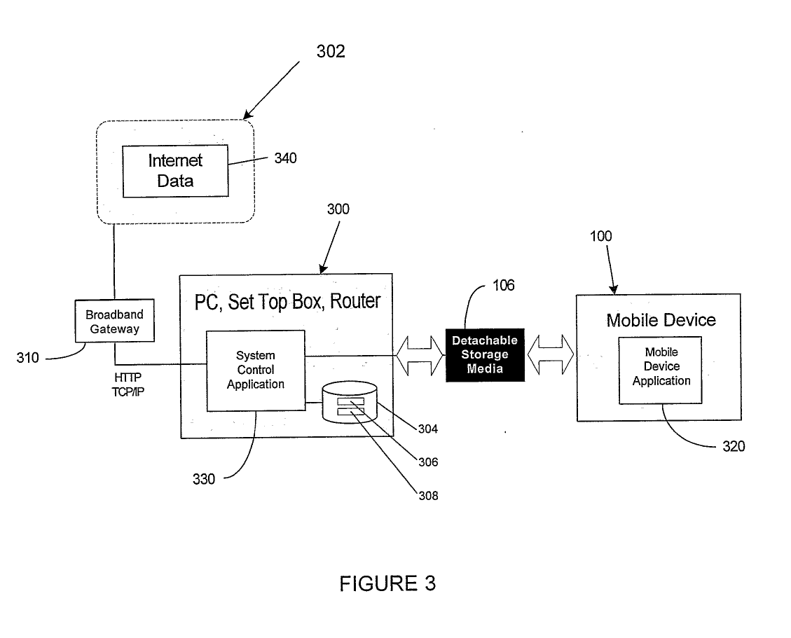

FIG. 3 shows a hardware block diagram of a PC or other source device 300 connected to the Internet 302 via a broadband gateway 310. PC 300 includes a hard disk drive 304 containing a content database 306 and content files 308. In one exemplary embodiment, the content database 306 is stored in a relational or object database on PC 300 under the supervision of a System Control Application 330 as will be described in further detail hereafter. In alternative embodiments, content database 306 may be stored in any file system on any persistent storage device on a PC, set top box, home network router, or other home appliance having database, i.e., memory storage, capabilities.

FIG. 3 also shows mobile device 100 that uses detachable storage media 106 to pass data between the mobile device 100 and PC or other source device 300. Once transferred to the mobile device, content data is manipulated by a Mobile Device Application 320 as will be described in further detail hereafter. It will be appreciated that although only one of each type of device is illustrated in FIG. 3, the disclosed system and method may support a plurality of like devices, for example, multiple mobile devices and/or multiple PCs or similar source devices, all of which may be configured to accept detachable storage media.

Description of Detachable Storage Media Usage—Software Block Diagram

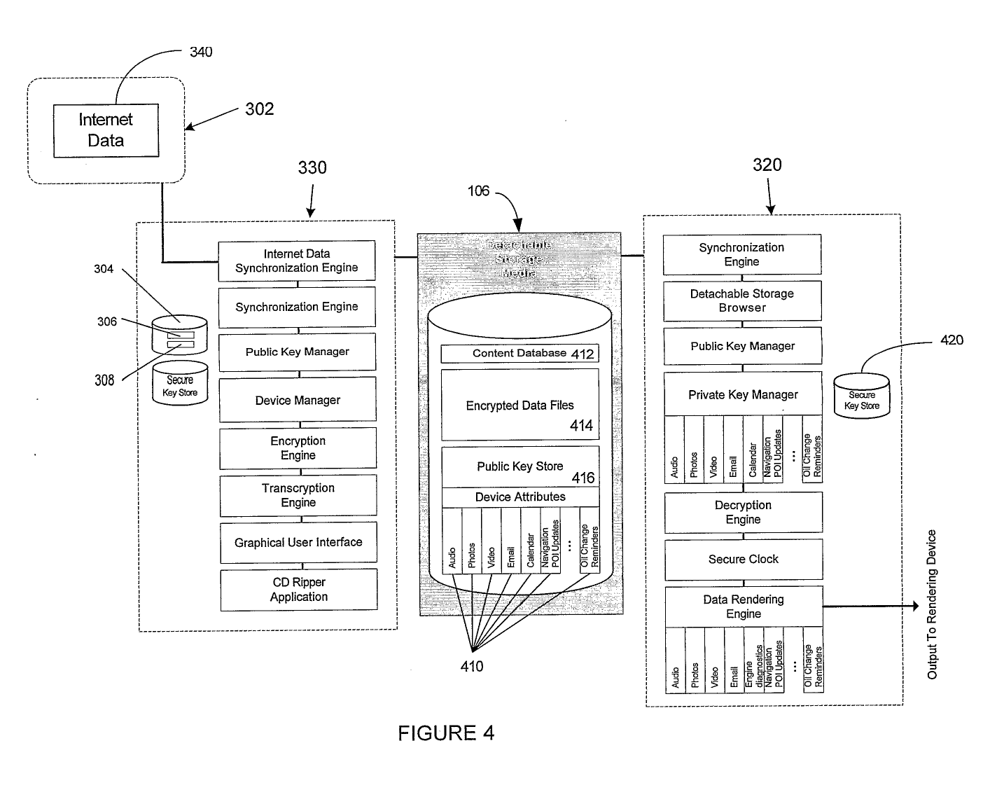

FIG. 4 shows the components of a System Control Application (SCA) 330 running on a PC or other device 300. In the exemplary system, the general purposes of the SCA are to store encrypted and non-encrypted data in a content database 306, create encrypted content 308, e.g., rip CDs to encrypted WMA or other audio format files, synchronize encrypted and non-encrypted data between Internet servers 340 and the PC 300, transcrypt encrypted data using a target device's public key, and synchronize encrypted and non-encrypted data to mobile devices 320 using public keys 410 associated with target devices obtained from detachable storage media 106 and the private key(s) originally provided when the particular data was acquired or ripped.

FIG. 4 also shows the components of a Mobile Device Application (MDA) 320 running on a mobile device. In the exemplary system, the general purposes of the MDA are to browse a content database, decrypt data that has been encrypted, and render decrypted data, e.g., play a WMA or other audio format track, display an oil change reminder, etc. In one embodiment, the MDA may maintain a secure key store 420 in which are stored one or more private keys for purposes as will be described hereafter. FIG. 4 also shows the contents of a detachable storage media 106. According to the exemplary system, the contents of the detachable storage media 106 include, but are not limited to a content database 412, encrypted and non-encrypted data 414, and a store 416 of public keys 410 for one or more mobile devices.

In one exemplary embodiment, the public key store 416 may be an XML file accessible to any software application that manages or uses public keys. In alternative embodiments, the public key store may be a relational or object database with application programming interfaces as appropriate. The content database 412 may be a relational or object database. In alternative embodiments, the content database may be a flat-file metadata descriptor of the content, or may use the detachable storage media file system to organize the data.

Operation—Initialize Detachable Storage Media

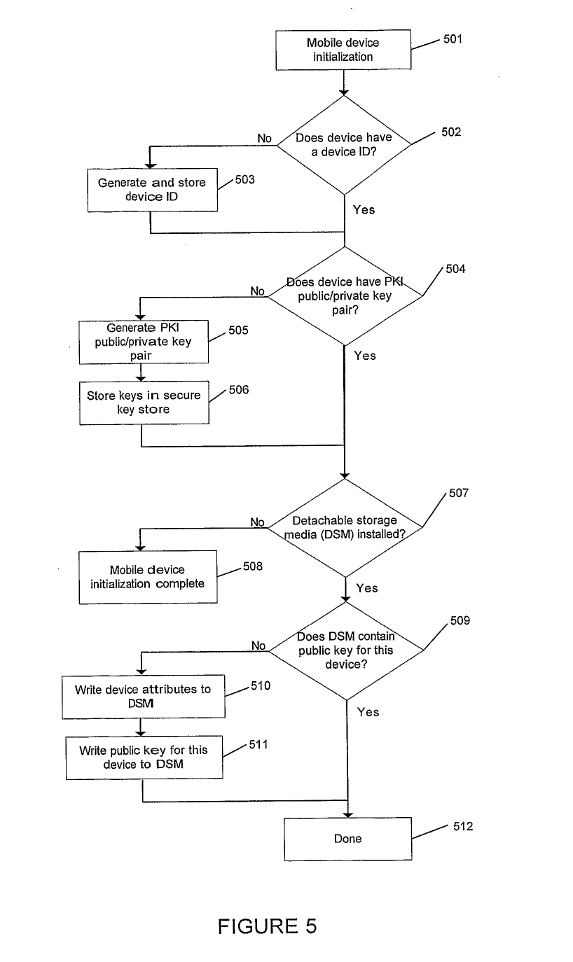

FIG. 5 illustrates the flow chart for an exemplary procedure to initialize detachable storage media with the public key of a mobile device. In one embodiment, initializing detachable storage media with public key information only needs to be done once during device initialization when the detachable storage media is inserted. When different detachable storage media is inserted, public key initialization must be performed on each newly inserted detachable storage media.

In the embodiment illustrated, when a mobile device is first initialized, the mobile device assigns itself a device ID, stores the device ID in a secure location on the device, uses the device ID to create a public PKI key and a private PKI key pair and, stores the public/private keys in a secure key store 420 as illustrated at steps 501 through 506. In alternative embodiments, the device ID and/or public and private keys may be externally generated and pre-loaded into the mobile device, e.g., during the manufacturing process. At steps 507 through 512, the mobile device then ascertains if a detachable storage media store is currently installed in the mobile device and if so, writes device attributes onto the detachable storage media, and writes the public key for the mobile device onto the detachable storage media.

In certain embodiments, a single public/private key pair may be sufficient for the mobile device. However, in other embodiments where a mobile device may need multiple public keys to handle specific data types, it will be appreciated that the mobile device may generate or be pre-loaded with a public/private key pair for each data type. In this case, the mobile device stores private keys for each data type in the secure key store 420. By way of example, a mobile device may require public keys for each data type where each “different” data type may be reflective of applications on the mobile device that were written by different software vendors, intended use or destination of the data, file formats for the data, etc.

In one exemplary embodiment, the public key store information 416 on the detachable storage media fully describes the device, types of data that can be decrypted by the mobile device, and public keys for each type of supported data. In alternative embodiments, the detachable storage media 106 may contain no meta information about a device or supported data types, containing only a single file describing the public key that is used to encrypt all data types for that mobile device.

An exemplary embodiment of an XML fragment which may be used for a public key store on detachable storage media is illustrated as follows. The exemplary XML fragment describes two mobile devices in an automobile. One device is an audio and video player device, while the other device performs engine diagnostics. Public keys are stored in the public key store for each data-type the device supports (the illustrative XML fragment only contains partial keys to limit the verbosity of the sample XML). By way of further example, the illustrated key store XML fragment contains public keys for WMA audio and WMV video data for the audio-video player device, and public keys for oil level and engine diagnostics for the engine diagnostics device. Each device also has a default public key for any data type that is not explicitly specified in the public key store. Although illustrated in the form of an XML fragment, it will be appreciated that in alternate embodiments, the public key store may be encoded in any syntax, e.g., ASN.1, C structure, etc. as will be appreciated by those skilled in the art.

In the exemplary embodiment, if detachable storage media 106 is installed in the mobile device and already contains a public key store, the mobile device adds key information to the public key store. In this embodiment, a mobile device may not modify key information for other devices. For example, a System Control Application 330 running in a PC or other source device 300 may have written public key information into detachable storage media for an oil change application. When the mobile device player adds public key information to the public key store, the mobile device player may not delete or modify the pre-existing oil change application device and key information.

Exemplary XML Fragment According to the Inventive System

| | <?xml version=“1.0” encoding=“utf-8” ?> |
|---|---|
| − | <root xmlns=“urn:schemas-upnp-org:device-1-0”> |
| − | <specVersion> |
| | <major>1</major> |
| | <minor>0</minor> |

</specVersion>

| | <URLBase>http://192.168.1.101:53147/</URLBase> |
|---|---|
| − | <deviceList> |
| − | <device> |
| | <deviceType>urn:schemas-upnp-org:device:MediaRenderer:1</deviceType> |
| | <presentationURL>/</presentationURL> |
| | <friendlyName>SimpleDevices Mobile Device Player (Demo)</friendlyName> |
| | <manufacturer>SimpleDevices, Inc.</manufacturer> |
| | <manufacturerURL>http://www.simpledevices.com</manufacturerURL> |
| | <modelDescription>SimpleDevices Detachable Storage Media Player |

Device</modelDescription>

| | <modelName>Mobile Device Player</modelName> |
|---|---|
| | <modelURL>http://www.simpledevices.com</modelURL> |
| | <UDN>uuid:SIMPLESD-0223-9813-4314-9084345ae415</UDN> |
| − | <publicKeyList> |
| − | <publicKey> |

<contentType>object.item.default</contentType>
<key>
WbZ/oxODJsIsYJoZq3whC50D/1xL0YdEUa8jMS/eRCcHedUN8xfnXPEhBFM
GC9TP
96s1r+vS5T2mmEcN6siqsc9g7Wp5E0wZbIEY2N7bQ//OITQfybGNb7c1mlhgO
N3r
vc+/2u . . . 4sPSmPxvA2BojigtJGeI+oUlj55VdZfIb+L9WbBh+YO3ahYE
</key>
</publicKey>

| | |
|---|---|
| − | <publicKey> |

<contentType>object.item.audioItem.musicTrack</contentType>
<contentDetail>audio/x-ms-wma</contentDetail>
<key>
mQGiBDt5nIIRBADPYWuWJNxgb2Tt7vYggQyfYnMby5kRCygbPuWFolcMw
4slIVoC
8o+xBADMMYdym3mu7eMShdNypcFXc+lof3LLlewFPkWAWR86qlDDyvS2l
v4ODz3s
ezHI9Sa . . .
dfGCLmYC+AS+o5QdKMByLi3SSGMYfDEWrQkQ2hyaXMgSm9u
</key>
</publicKey>

| | |
|---|---|
| − | <publicKey> |

<contentType>object.item.videoItem.videoTrack</contentType>
<contentDetail>audio/x-ms-wmv</contentDetail>
<key>
OwACAggAi0zlctHDID2ZmH8HyPBa23vkoTrmLqaTvw3Wy1kzRecOkH9RsD
1EBguN
nb44z4WpRei5E8Bx5empO2wu+zsNaLjK9Pv3B9i0hrTt6W5q5tBv014Ye41cT8j
X
1CRzCrY . . . 8esFjEIaJVLPfrNRb/BPB7jo7HROaBvNNgOLHrDns0ib0J3
</key>
</publicKey>
</publicKeyList>
</device>
<device>

<deviceType>urn:schemas-upnp-

org:device:AutoDiagnosticsDevice:1</deviceType>

<presentationURL>/</presentationURL>
<friendlyName>SimpleDevices Mobile Device Diagnostics

(Demo)</friendlyName>

<manufacturer>SimpleDevices, Inc.</manufacturer>
<manufacturerURL>http://www.simpledevices.com</manufacturerURL>
<modelDescription>SimpleDevices Detachable Storage Media Diag

Device</modelDescription>

| | <modelName>Mobile Device Automotive Diagnostics</modelName> |
|---|---|
| | <modelURL>http://www.simpledevices.com</modelURL> |
| | <UDN>uuid:SIMPLESD-8482-6719-4a34-aec314943431</UDN> |
| − | <publicKeyList> |
| − | <publicKey> |

<contentType>object.item.default</contentType>
<key>
9vPJI8BD8KVbGI2Ou1WMuF040zT9fBdXQ6MdGGzeMyEstSr/POGxKUAYE
Y18hKcK
ctaGxAMZyAcpesqVDNmWn6vQClCbAkbTCD1mpF1Bn5x8vYlLIhkmuquiXs
NV6TIL
OwACAg . . .
TDAZmH8HyPBa23vkoTrmLqaTvw3Wy1kzRecOkH9RsD1EBguN
</key>
</publicKey>

| | |
|---|---|
| − | <publicKey> |

<contentType>object.item.auto.engine</contentType>
<contentDetail>auto/x-sd-oil-level</contentDetail>
<key>
Y29hbHR6IDxjaHJpc2pAcmlvcG9ydC5jb20+iQBYBBARAgAYBQI7eZyCCAs
DCQgH
AgEKAhkBBRsDAAAAAAoJEAivuUzzD7OGZe8AmgMd4yHrrHb9vfOmEfqA
ZyRNmB/f
AKDh8qs . . . uK0FkaUaypgiLkCDQQ7eZyCEAgA9kJXtwh/CBdyorrWqULz
</key>
</publicKey>

| | |
|---|---|
| − | <publicKey> |

<contentType>object.item.auto.engine</contentType>
<contentDetail>auto/x-sd-diagnostics</contentDetail>
<key>
vc+/2u975e/WpNE7/DPSmPxvA2BojigtJGeI+oUlj55VdZfIb+L9WbBh+YO3ah
YE
8o+xBADMMYdym3mu7eMShdNypcFXc+lof3LLlewFPkWAWR86q1DDyvS2l
v4ODz3s
Q1QTuKc . . . PkCeg8FsOw5QEIHxqiM4c5hi8mTPIzrAqR4HiMyGCY2nvwi
</key>
</publicKey>
</publicKeyList>
</device>
</deviceList>
</root>

### Operation—Synchronizing Encrypted Internet Data to Mobile Devices

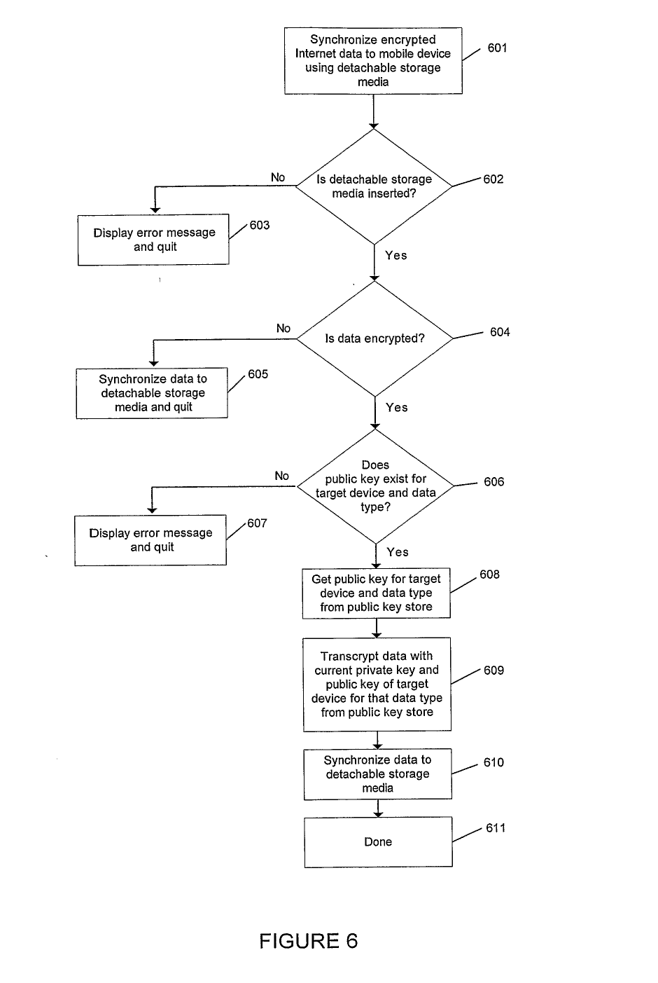

Turning now to FIG. 6, there is illustrated an exemplary procedure to synchronize encrypted Internet data to a mobile device 100 using a public key store 416 initialized as described in conjunction with FIG. 5. An exemplary scenario for synchronizing music and videos purchased from Internet online music/video stores to automotive mobile devices using detachable storage media is illustrated. First, in steps 601 through 606 it is determined that a detachable storage media is inserted, that the data to be transferred is in fact encrypted, and that a public key is available from the detachable media device for the desired target mobile device and the data type. If so, at steps 608 through 611 the data is transcrypted using the private key internally associated with the data and the public key associated with the target device. It should be appreciated that although in this example the same detachable media is used to both transfer the encrypted data from the source device to the target mobile device and transfer the public key value from the target mobile device to the source device, in other embodiments these transfers may be accomplished using separate or even different methods or media (e.g., wireless methods, wired methods, etc).

Operation—Synchronizing Encrypted Ripped CD Content to Mobile Devices

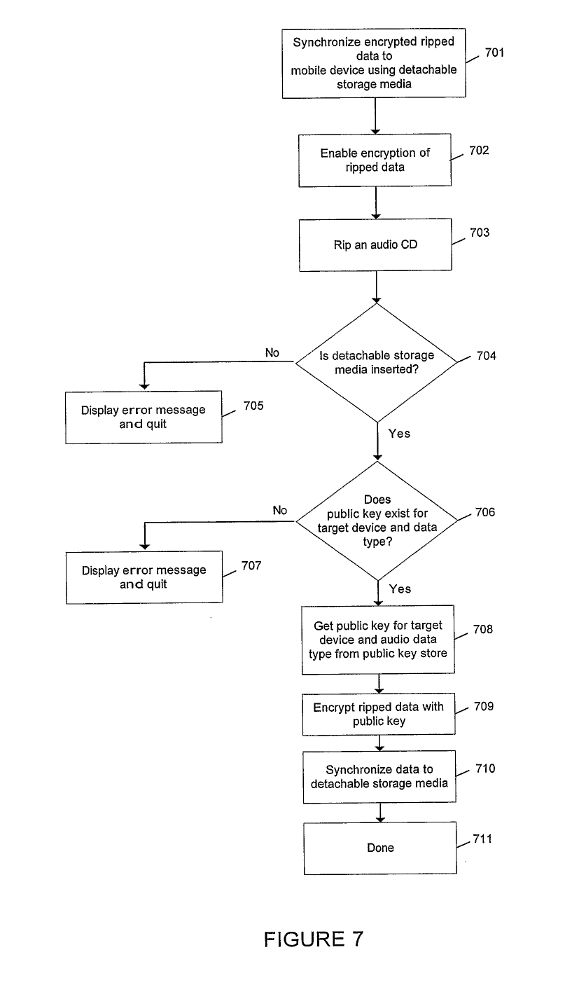

FIG. 7 illustrates an exemplary method to synchronize encrypted ripped CD content at a source PC or other source device 300 to a mobile device 100 using a public key store initialized as described in conjunction with FIG. 5. The exemplary process shown in steps 701 through 711 is similar to that described above in conjunction with FIG. 6 except that in this example full transcryption is not necessary since the data to be transferred is not previously encrypted.

Operation—Synchronizing Encrypted Ripped CD Content from Mobile Devices

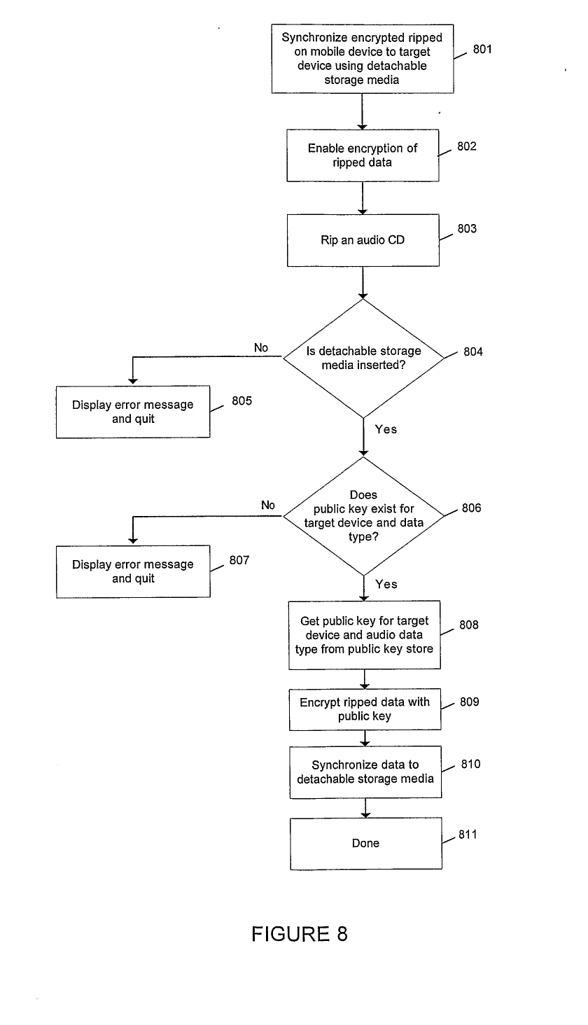

FIG. 8 illustrates an exemplary method to synchronize ripped CD content at a mobile device 100 to a target PC or other target device 300 a using a public key store initialized as described in conjunction with FIG. 5 at the target PC or other target device 300. The exemplary process shown in steps 801 through 811 is similar to that described above in conjunction with FIG. 6 except that in this example full transcryption is not necessary since the data to be transferred is not previously encrypted.

Operation—Synchronizing Mobile Device Data to Internet Service Providers

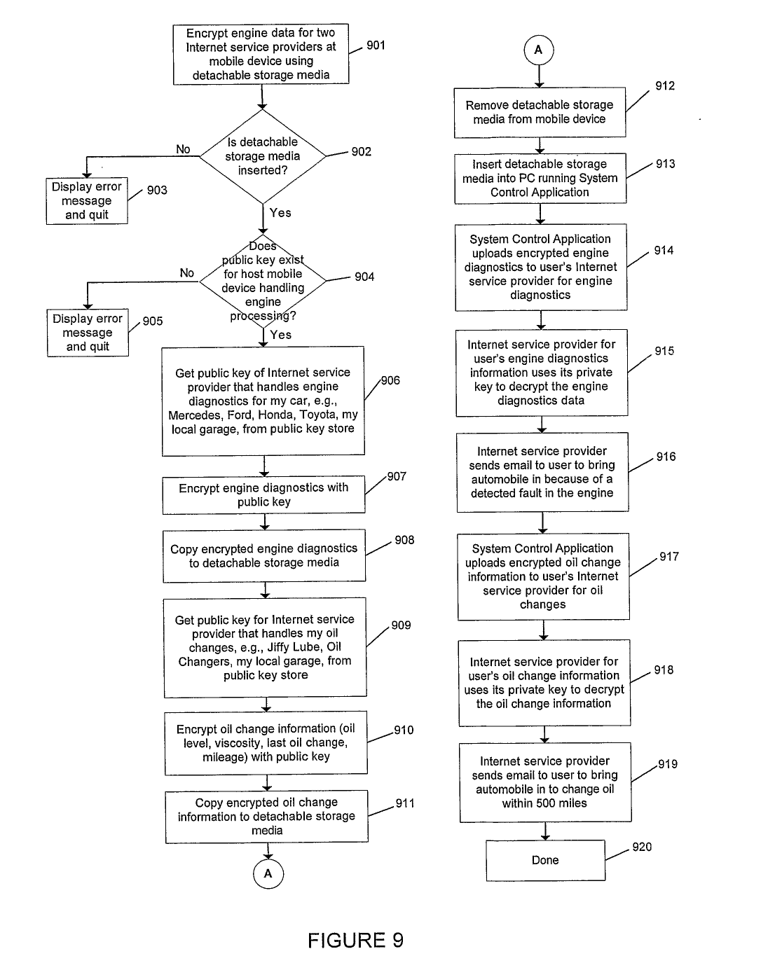

FIG. 9 illustrates an exemplary method to enable a mobile device in an automobile to generate and encrypt data for multiple Internet service providers simultaneously. For purpose of this example it is assumed that each Internet service provider requires different public keys.

In this example, the initialization procedure described in FIG. 5 may also used by Internet service provider and PC applications to add a public key to the public key store on detachable storage media. By default, detachable storage media may have one public key per device. However, as illustrated in FIG. 9, in certain embodiments it may be appropriate to store multiple public keys per device per data type in a single detachable storage media 106 At steps 901 through 905, the mobile device first ascertains if a detachable storage media containing an appropriate public key for an engine diagnostic analysis service is installed. If so, at steps 906 through 911, engine diagnostic data (and oil quality data, if a separate service is provided for this) is encrypted using the appropriate public key(s) and copied onto the detachable storage media. The detachable storage media 106 is then removed and subsequently inserted into a PC or other source device 300 (steps 912, 913). At steps 914 through 920, the System Control Application 330 resident in PC 300 then uploads this data forwards the encrypted information to the appropriate Internet based diagnostic and/or maintenance service providers. In the illustrative embodiment, any repair or maintenance recommendations that result from analysis of this data is conveyed to the user via email messages (steps 916 and 919). In an alternative embodiment, the detachable storage media 106 may be sent directly to the appropriate Internet based diagnostic and/or maintenance service providers.

Operation—Render Encrypted Data at Mobile Device

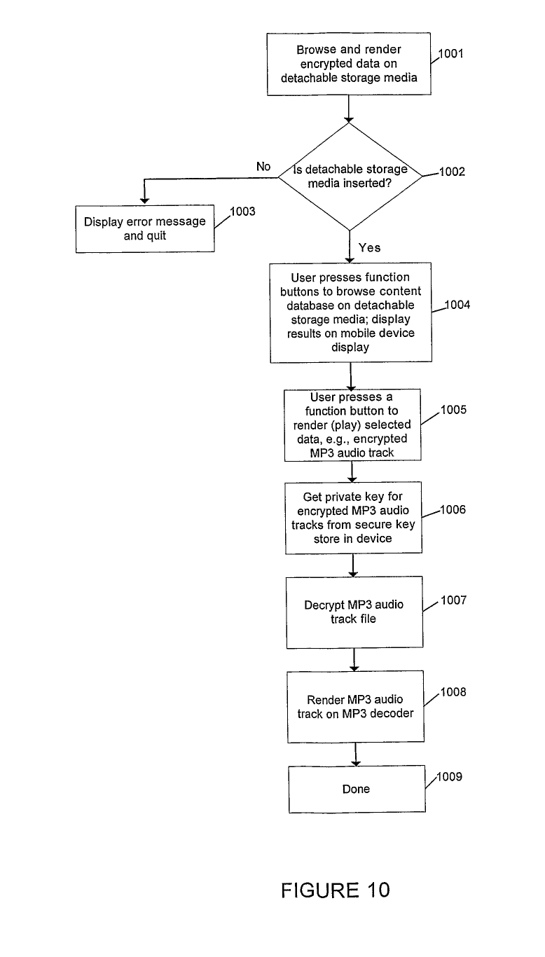

FIG. 10 illustrates an exemplary method to render encrypted data (audio data in the exemplary system) on a mobile device 100. If a detachable storage media device is installed (steps 1001 through 1003), a user may browse a content database 412 using function buttons 104 and display 102 (step 1004) and select an item to play back (step 1005). Once an item has been selected, at steps 1006 through 1009 the mobile device 100 may retrieve an appropriate private key from private key store 420 and use this to decrypt and render the audio data.

In this context, it will be appreciated that to enforce digital rights management of data, it may be desirable that a mobile player device 100 maintains a secure real time clock function that cannot be modified by a user. In one exemplary embodiment, initialization of this secure clock is not accomplished using detachable storage media 106. Rather, the real time clock in mobile device 100 may be set by an Internet service after physically connecting the mobile device to a USB port on a PC or other source device. Alternative embodiments may update the clock automatically by radio signals linked to the U.S. Atomic Clock in Fort Collins, Colo., update the clock using a service provided on the PC or Internet, etc.

While various concepts have been described in detail, it will be appreciated by those skilled in the art that various modifications and alternatives to those concepts could be developed in light of the overall teachings of the disclosure. For example, it should be appreciated that various configurations of mobile, portable, battery powered devices and servers or other similar electronic devices may be implemented in an encryption based synchronization system, and as such many combinations and variations of the above described synchronization methods, parameters, and settings are possible without departing from the spirit and scope of the present invention. Additionally, while the embodiments presented above are described primarily in the context of electronic devices having media synchronization and rendering capabilities as being most broadly representative of a device for which the synchronization system and method of the present invention is most applicable, it will be appreciated that the teachings of this disclosure may be equally well applied to other devices and media types wherein encryption based synchronization functions are required (i.e., data delivery devices, cell phones, electronic book readers, remote controls, STBs and the like) without departing from the spirit and scope of the present invention. Additionally, it be understood that the detachable media storage described above may be a standalone device such as an SD card, USB key fob, etc., or may be incorporated into another item, for example as part of an electronic automobile key, an automobile or boat security alarm remote controller, a CD caddy, a smart card, a phone headset, etc., all without departing from the spirit of the invention. Still further, while the disclosed exemplary embodiments utilize a detachable storage media which may be physically installed and removed from the respective devices, it will be appreciated that other methods may be equally suitable to accomplish the transfer of public key information. For example a low data rate wireless communication link such as provided by IrDA or Bluetooth, while insufficient for transfer of the complete content files themselves may still be adequate for transfer of key information. Still further, it will be appreciated that while in the context of encryption based synchronization the source device is generally referred to as a PC, server, set top box, media hub, or other similar fixed computing device, and the target device as a mobile, portable, or battery powered device, it will be understood that any electronic device, including but not limited to those described herein, may function as a source or target for receipt, handling, and transfer of encryption information and associated data files without departing from the spirit or scope of the current invention. As such, the particular concepts disclosed are meant to be illustrative only and not limiting as to the scope of the invention which is to be given the full breadth of the appended claims and any equivalents thereof.

All documents cited within this application for patent are hereby incorporated by reference in their entirety.

What is claimed is:

1. In a system comprised of a data target device, a data source device, and a storage media transferable between the data target device and the data source device, a method for transferring data, comprising:
using the storage media to transfer an encryption key associated with the data target device to the data source device;
using the encryption key at the data source device to encrypt the data;
transferring the encrypted data from the data source device to the data target device; and
decrypting the encrypted data at the data target device.

2. The method as recited in claim 1, wherein the encryption key is a public key and the data target device maintains a private key complimentary to the public key for use in decrypting the encrypted data.

3. The method as recited in claim 2, comprising using at the data target device an ID associated with the data target device to create the public key and private key pair.

4. The method as recited in claim 2, wherein the public key and private key pair are utilized to encrypt and decrypt only data having a predetermined data type.

5. The method as recited in claim 1, comprising using the storage media to transfer the encrypted data from the data source device to the data target device.

6. The method as recited in claim 1, wherein the data comprises a further encryption key.

7. The method as recited in claim 1, wherein the data target device comprises a mobile device.

8. In a system comprised of a mobile device associated with an vehicle, a target device, and a storage media transferable between the mobile device and the target device, a method for transferring data, comprising:
using the storage media to transfer an encryption key associated with the target device to the mobile device;
using the encryption key at the mobile device to encrypt the data indicative of a state of the vehicle;
transferring the encrypted data from the mobile device to the target device; and
decrypting the encrypted data at the target devices.

9. The method as recited in claim 8, comprising uploading the decrypted data from the target device to a computer associated with a vehicle service center.

10. The method as recited in claim 8, wherein the target device comprises a computer associated with a vehicle service center.

11. The method as recited in claim 9, wherein the uploading is via the Internet.

12. The method as recited in claim 8, comprising using the storage media to transfer the encrypted data from the mobile device to the target device.

13. A data transfer system, comprising:
a data target device having an associated encryption key;
a data source device having an encryption algorithm; and
a storage media transferable between the data target device and the data source device for use in transferring the encryption key from the data target device to the data source device whereby the encryption algorithm of the data source device utilizes the encryption key to encrypt data such that the data is decrytable and renderable only at the data target device.

14. The system as recited in claim 13, wherein the encryption key is a public key and the data target device maintains a private key complimentary to the public key for use in decrypting the encrypted data.

15. The system as recited in claim 14, wherein the data target device has an ID that is used to create the public key and private key pair.

16. The system as recited in claim 14, wherein the public key and private key pair are utilized to encrypt and decrypt only data having a predetermined data type.

17. The system as recited in claim 13, wherein the storage media is used to transfer the encrypted data from the data source device to the data target device.

18. The system as recited in claim 13, wherein the storage media comprises an vehicle ignition key.

19. The system as recited in claim 13, wherein the data comprises a further encryption key.

20. The system as recited in claim 13, wherein the data target device comprises a mobile device.
